(19) United States
(12) Patent Application Publication
(10) Pub. No.: US 2003/0015494 A1
(43) Pub. Date: Jan. 23, 2003

(54) Single layer resist lift-off process and apparatus for submicron structures

(75) Inventors: Sethuraman Jayashankar, Pittsburgh, PA (US); Andrew Robert Eckert, Pittsburgh, PA (US); Carl F. Seiler JR., Pittsburgh, PA (US)

Correspondence Address: BUCHANAN INGERSOLL, P.C., ONE OXFORD CENTRE, 301 GRANT STREET, 20TH FLOOR, PITTSBURGH, PA, 15219, US

(73) Assignee: Seagate Technology LLC

(21) Appl. No.: 10/087,510

(22) Filed: Mar. 1, 2002

Related U.S. Application Data
(60) Provisional application No. 60/306,681, filed on Jul. 20, 2001.

(51) Int. Cl. C23F 1/00; B44C 1/22; C03C 15/00; C03C 25/68

(52) U.S. Cl. 216/63

(57) ABSTRACT

A single layer resist lift-off process and apparatus for sub-micron features can include applying concentrated, localized megasonic energy on the surface of a wafer to break sidewall dielectric layers on a lift-off structure to facilitate successful lift-off. Additional steps can include using surfactants in the lift-off fluid to enhance wetting and controlling the chemistry of the lift-off fluid to create conditions which facilitate effective lift-off by creating repulsive Van der Waals forces between the lift-off structures and underlying surfaces. The lift-off fluid can also be formulated to react with the photoresist so that when the sidewall layer is cracked, the reaction between the lift-off fluid and the photoresist can initiate and speed the lift-off process. The lift-off apparatus can include a megasonic head having multiple transducer elements which can be individually operated at different frequencies and power levels to optimize lift-off of differently sized features on the wafer.

### CROSS REFERENCE TO RELATED APPLICATIONS

This application is related to U.S. Provisional Patent Application Serial No. 60/306,681, filed Jul. 20, 2001.

### FIELD OF INVENTION

The invention relates generally to lift-off processes wherein a substrate is first covered with a photoresist everywhere except in certain areas in order to define a particular feature, a dielectric is then deposited covering the photoresist and the substrate, after which the photoresist is lifted-off leaving only the feature on the substrate. More particularly, the invention relates to resist lift-off processes and an apparatus especially suited for defining feature sizes smaller than about one micron.

### BACKGROUND OF THE INVENTION

Lift-off techniques have been used for the past 20 years for the definition of patterned structures. Traditionally, lift-off processes have been used under two conditions (a) when a dielectric lines have to be patterned on substrates where the use of chemical or plasma etching is undesirable or incompatible with the materials and processes involved and (b) when tight linewidth control is required.

Generally speaking, lift-off processing is an additive process where the substrate, also commonly referred to as the “wafer,” is covered with a photoresist everywhere except in areas where the metallization, i.e., dielectric deposition, is desired. The dielectric thin film (typically less than 0.5 μm) is then deposited over the entire wafer surface, with the deposited thin film being in contact with the surface in the exposed areas as well as on top of the photoresist. The photoresist is subsequently removed lifting the unwanted dielectric away from the wafer surface, leaving behind the desired dielectric pattern. The terms “metal” and “dielectric” are generally interchangeable as used in the context of this disclosure to describe the deposition material. As such, and for sake of convenience, only the term “dielectric” will be used hereinafter with the understanding being that “metal” is interchangeable with or encompassed by “dielectric.”

An example of a theoretical ideal lift-off process as just described is illustrated in FIG. 1a, which illustrates a single layer photoresist structure 15 applied on the surface of a substrate, or wafer, 18 in a first stage of the process. In the second stage, a dielectric layer 21 is deposited, as by any of various well known methods, over the entire wafer 18 and photoresist structure 15. In the final stage, the photoresist 15 has been successfully lifted off, leaving only the portion of the dielectric layer 21 which was applied directly on the surface of the wafer 18.

However, the ideal process illustrated in FIG. 1a generally cannot be achieved since some dielectric will almost inevitably be deposited on the sidewalls of the photoresist 15. This is because the idealized lift-off process assumes that the thin film deposition will take place normal to the surface of the wafer 18, i.e., the deposition of the dielectric will be fully collimated. In practice this generally cannot be fully accomplished. Instead, the dielectric layer 21 is typically delivered at an angle to the wafer 18 surface, with the result that dielectric buildup occurs on the sidewalls 16 of the photoresist structure 15, as shown in FIG. 1b, thus resulting in a sidewall dielectric layer 22. As shown, the stages of the process are the same, except, unlike the theoretical ideal, the dielectric layer 21 is not fully collimated. Rather, in more conformal dielectric film deposition processes, the dielectric layer 21 will typically fully cover the photoresist 15, including the sidewalls 16, thus forming the sidewall dielectric layer 22, which impedes removal of the photoresist structure 15. Moreover, the sidewall dielectric layer 22 may adhere to the sidewalls 16 of the photoresist 15, making lift-off removal very poor and resulting in very rough linewidth. When the photoresist 15 is subsequently removed during lift-off processing, dielectric buildup can remain on the substrate 18, causing what is commonly referred to as a “wing tip” formations 19 on the photoresist 15, resulting in incomplete lift-off.

It is thus apparent that the resist profile is one of the critical parameters that affects the success of a clean lift-off process. Positive sloped 24, or rounded 27, resist profiles as shown, for example, in FIGS. 2a and 2b, respectively, (which can be the result of dose variations as a function of thickness, diffraction effects due to mask-wafer distance, ion-milling, etc.), are the most susceptible to sidewall film deposition and, consequently are generally the most difficult to lift-off. In contrast, negative resist profiles 36, or resist overhangs 39, as illustrated in the bi-layer resist configurations shown in FIGS. 3a and 3b, for example, are the best suited for clean lift-off processes due to the ability to produce a break in the dielectric film 21 continuity across the patterned feature. A variety of techniques are known in the prior art, for example the use of bi-layer or multi-layer resists 36, 39, referred to above, and pretreatment of the resist 15, 36, 39 surface. Also, dielectric lift-off assist layers have been used in the prior art to modify the resist profile so as to create a discontinuity in the dielectric film 21 across the lift-off pattern, and thus aid lift-off. A break in the dielectric film 21 continuity can be important not only for the obvious need to disconnect the dielectric film 21 on the photoresist 15 (which is to be lifted off) from the dielectric film 21 on the substrate 18 (which is to remain), but also to permit penetration by a lift-off solvent into direct contact with the photoresists 15. The lift-off solvent can be designed to chemically react with the photoresist 15 to enhance lift-off of the photoresist 15 from the substrate 18.

Consequently, it can be understood that conventional successful lift-off processes can be predicated on basically four occurrences: (a) a stable photoresist profile; (b) a discontinuity in the dielectric film profile across the lift-off pattern; (c) the presence of a “re-entrant” resist profile which facilitates a break in the dielectric film, and thus penetration and direct contact of the lift-off solvent with the photoresist; and (d) effective removal of the lift-off structure away from the wafer surface. Conventionally, steps and (d) can usually be accomplished, or facilitated, through the ultrasonication of the wafer in a suitable solvent such as acetone or NMP (N Methyl Pyrolidone), methylethyl ketone, or trichloroethylene, which dissolve the photoresist without attacking the thin film to be patterned. The ultrasonication helps in the diffusion and penetration of the lift-off solvent at the thin film/photoresist interface, and also in the mechanical removal of the lifted off structures. Modified versions of the lift-off process described above have been used in the production and patterning of various elements of thin film magnetic heads.

Lift-off Processes can be most problematic where extremely small features are involved. For example, the fabrication of magnetic recording heads requires the precise definition of various read sensors and write elements. Areal densities of 50 GB/in² and above require the fabrication of sensor and write element widths less than 0.5 μm. Lift-off processes for the definition of such small features pose additional challenges. For one, the extremely narrow feature sizes require the use of advanced patterning techniques such as e-beam lithography. For such feature sizes, conventional lift-off techniques generally do not work as well, especially for linewidths below 300 nm. This can be due to, inter alia, the following limitations:

(a) Smaller feature sizes such as those in the range of 200 nm and below typically require the use of electron beam lithography. The conventional bi-layer and multi-layer resist processing sequences used to create resist overhang profiles have been developed for and usually work well with conventional (UV) lithography.

(b) Resist undercut is very difficult below 200 nm even if bi-layer or multi-layer resist strategies were possible with e-beam or other lithography; even if possible, these would not be easily amenable to manufacturing. This is because of the difficulty in controlling the degree and the uniformity of the undercut when the critical dimensions are of the same order of magnitude as the resist undercut thickness. This can lead to unacceptable variations in linewidth and, hence, in device performance.

(c) Also, resist undercut/overhang profiles also lead to problems with maintaining the structural integrity of the resist.

Some issues associated with conventional lift-off processes should be understood. Specifically, a conventional lift-off scheme, in accordance with some of the principles described above, for example, aims to fabricate a patterned spin valve stack with a surrounding field layer of a dielectric alumina film (with thickness conformal to the sensor stack thickness) through a series of operations encompassing GMR stack deposition, stack patterning through e-beam lithography via negative e-beam resist, ion milling of the sensor stack, ion beam deposition of dielectric (alumina), sidewall cleaning ion mill (Lift-off assist ion mill), and pattern lift-off. This particular process aims to combat the problem of sidewall coverage of the dielectric on the photoresist walls through the use of the lift-off assist ion mill, a procedure wherein the sidewalls, specifically the layer of dielectric deposited on the sidewalls, are subjected to an extremely high angle ion mill.

However, the actual lift-off of the photoresist tends to be difficult to implement following the teachings of such processes because of the presence of significant alumina on the sidewalls of the photoresist. The sidewall alumina can be present due to the following reasons:

(a) subsequent to the e-beam definition of the sensor pattern, the wafer undergoes ion beam milling to define the sensor stack. This ion beam milling creates secondary damage to the e-beam resist, causing a rounded e-beam resist profile. Subsequent alumina deposition on the field areas during the lift-off pattern definition cause alumina deposition along the rounded photoresist sidewall slopes created by the prior sensor defining ion mill; and

(b) The alumina deposition is not fully collimated. For this reason, there is typically significant sidewall coverage. The sidewall coverage ratio (defined as the ratio of the thickness of the sidewall deposition to the thickness of the normal deposition) can typically be about 20%. Thicker sensor stacks require thicker alumina/dielectric coverage to bring the sensor level with the dielectric, which results in the creation of thicker dielectric coverage on the sidewalls.

The thick dielectric sidewalls encapsulate the underlying photoresist in the lift-off structure thus preventing lift-off solvents, such as, for example, hot NMP, from contacting and reacting with the photoresist to enhance/complete the lift-off. The high angle lift-off assist ion mill is not always effective in removing the sidewall dielectric thickness completely. Moreover, as material on the sidewall is removed, typically so is some material lying along the plane of the wafer. This creates topography differences between the sensor stack and the dielectric, which can cause potential shorting of the device elements.

Yet another important aspect which has been overlooked according to prior art lift-off processes is the clearing mechanism of the fine features of lifted off structures. Traditional lift-off processes use techniques such as ultrasonication in solvents such as hot NMP to detach and clear the lifted off features from the wafer surface. These techniques utilize gravitational forces to clear the lifted off features from the wafer surface, and are effective at lift-off feature sizes of around 1 μm and above. However, these techniques generally do are not effective for submicron feature sizes, i.e., features smaller than 1 μm. In the case of submicron features, the lift-off efficiency of mechanical methods such as ultrasonication falls drastically as feature sizes shrink. For feature sizes below 1 μm, Van der Waals forces are the most dominant, and exceed the mechanical forces by orders of magnitude. Consequently, alternative feature separation techniques can be required.

From the preceding, it is clear that there exists a need to find a method to pattern and lift-off structures for line widths and feature sizes smaller than 1 μm, and preferably smaller than 300 nm. The method should also preferably have a high lift-off efficiency, be reliable, robust, introduce no contamination to the wafer surface, and not expose the wafer devices to chemicals that could cause deleterious effects on the wafer material. The method should also be capable of lifting off structures with sidewall dielectric layer thickness by breaking the sidewall alumina layer. The method should also accommodate a range of linewidth sizes and should be the least time consuming so as to not adversely affect process throughput. The process chemistries should not adversely react with and degrade the devices being fabricated and the method should be non-contact, so as not to cause collateral damage to the wafer surface, and amenable to use with a wide range of different materials and chemicals, including the capability for extension to other fabrication processes for similar pattern scales.

### SUMMARY OF THE INVENTION

A single layer resist lift-off process and apparatus for lift-off patterning of submicron features is provided wherein acoustic, and particularly megasonic energy can be applied in a concentrated, highly localized method designed to break sidewall dielectric layers on the photoresist to facilitate successful lift-off. Additionally, another lift-off process, which can be employed as an enhancement of the above lift-off process utilizing megasonic energy can include controlling the chemistry of the lift-off fluid to create conditions which facilitate lift-off of the photoresist from the substrate. In particular, the lift-off fluid can be formulated to create repulsive Van der Waals forces between the lift-off structures and the underlying surfaces to effect a successful lift-off. Moreover, further enhancements can include adding surfactants in the lift-off fluid to enhance wetting of the photoresist, particularly when the sidewall dielectric layer is cracked. Similarly, the lift-off fluid can also be formulated to react with the photoresist, so that when the dielectric sidewall layer is cracked in using megasonic energy the reaction between the lift-off fluid and the photoresist can both initiate and quicken the lift-off process.

Other details, objects, and advantages of the invention will become apparent from the following detailed description and the accompanying drawings figures of certain embodiments thereof.

### BRIEF DESCRIPTION OF THE DRAWINGS

A more complete understanding of the invention can be obtained by considering the following detailed description in conjunction with the accompanying drawings, in which:

FIGS. 1a and 1b illustrate a theoretically ideal and actual typical lift-off processes, respectively.

FIGS. 2a and 2b illustrate unfavorable photoresist profiles.

FIGS. 3a and 3b illustrate re-entrant photoresist profiles.

FIG. 4 illustrates a certain embodiment of a lift-off process according to the invention.

FIG. 5 is a simplified representation of a prior art type device for applying megasonic energy to effect resist lift-off.

FIG. 6 is a simplified representation of another prior art type device for applying megasonic energy in close proximity to the surface of a wafer.

FIG. 7 illustrates how the megasonic device shown in FIG. 6 is conventionally utilized to clean wafers.

FIG. 8 illustrates how the megasonic device shown in FIG. 6 can be used according to a certain embodiment of the invention to crack dielectric sidewall layers covering lift-off structures on the surface of the wafer.

FIG. 9 shows a certain embodiment of a transducer array which can be used with a megasonic device of the type shown in FIG. 6 in place of the conventional transducer.

FIG. 10 is a cross section view taken along line X-X in FIG. 9.

FIG. 11 is a graph of Zeta potential of various materials vs. pH.

FIG. 12 is a graphical comparison of Van der Waals forces and gravitational forces.

FIG. 13 is a pictorial representation of the results of a successful lift-off process according to a certain embodiment of the invention.

FIG. 14 is a pictorial representation of the results of a successful lift-off process according to another certain embodiment of the invention.

FIG. 15a is a pictorial representation of a wafer having a 0.1 μm feature just prior to lift-off.

FIG. 15b is a pictorial representation of the wafer shown in FIG. 15a after a successful lift-off process according to another certain embodiment of the invention.

FIG. 16a is a pictorial representation of a wafer having a 0.25 μm feature just prior to lift-off;

FIG. 16b is a pictorial representation of the wafer shown in FIG. 16a after a successful lift-off process according to another certain embodiment of the invention.

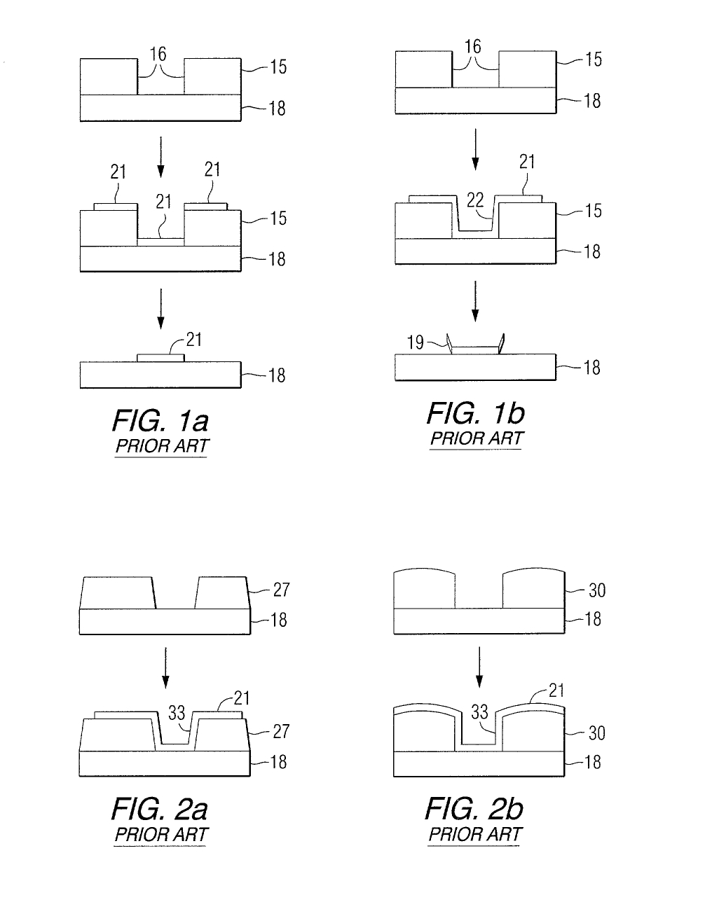

### DETAILED DESCRIPTION

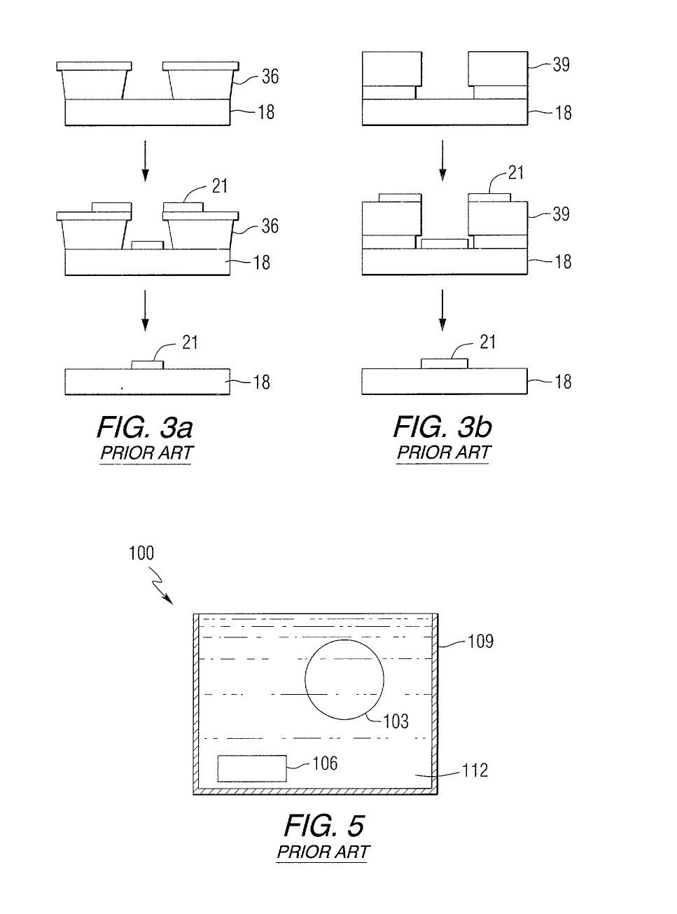

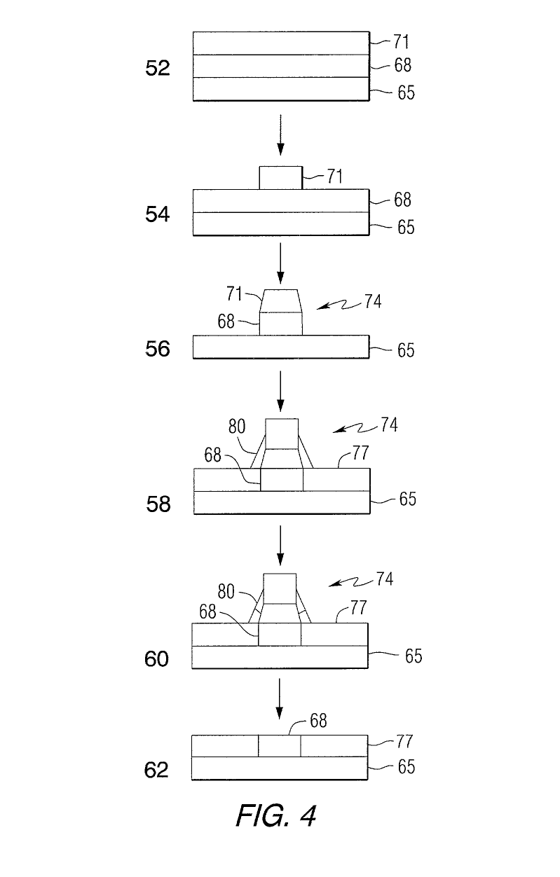

Referring now to the drawing figures wherein like reference numbers designate the same or corresponding elements, a certain embodiment of a single layer resist lift-off process 50 according to the invention is illustrated in FIG. 4. As shown, GMR stack deposition of a sensor layer 68 and photoresist layer (“PR”) 71 on a shield 65 has already been completed in the First stage 52 of six stages 52-62 of the single layer resist lift-off process 50. In the cross section view in FIG. 4 of the GMR stack deposition, a substrate/wafer is not shown below the shield element 65. A wafer could be present, or the shield could simply be the substrate. In the second stage 54, stack patterning has been performed, for example using e-beam lithography via negative e-beam resist. This process defines the width of the photoresist 71, to which the width of the sensor 68 will ultimately be made to correspond. In the third stage 56, the sensor stack 74, comprised of the sensor 68 and photoresist 71, is defined by, for example, ion beam milling of the sensor 68, to cause the width of the sensor 68 to correspond to the width of the photoresist 71. As can be seen, the ion beam milling of the sensor 68 can cause secondary damage to the photoresist 71, resulting in the undesirable positive sloped, or rounded, profile shown in this stage. This undesirable profile has the disadvantages described previously in connection with FIGS. 3a and 3b. The fourth stage 58 illustrates the sensor stack 74 subsequent to ion beam deposition of the dielectric layer 77, which in this example, can be alumina. In this process, the alumina layer 77 deposited on the shield 65 is desired to have a thickness equal to the thickness of the sensor 68. However, as can be seen, a significant alumina sidewall layer 80 has been deposited on the sidewalls of the photoresist 71, which can be as a result both of the dielectric deposition not being fully collimated and the positive sloped profile of the photoresist 71 caused by the ion beam milling of the sensor 68 in the preceding stage. It is this sidewall alumina layer 80 which must be dealt with to effect a successful lift-off photoresist 71 and excess alumina 77. In the fifth stage 60, lift-off is initiated by cracking the dielectric sidewall layer 80 via the application of localized, concentrated acoustic energy, in this case megasonic energy, for example, on the order of 1.5 MHz at 100 watts, applied in close proximity to the surface of the shield 65. Each of the first 52 through fourth 58 and sixth 62 stages can be individually well known to those skilled in the art, with regard to how the particular process is generally performed. However, according to the invention, the fifth stage 60 can be performed to break the sidewall dielectric layer 80 using megasonic energy to effect lift-off of submicron structures, and is not known to have been done in the prior art.

Additional processing stages could also be utilized besides the six stages 52-62 described. For example, another stage can be interposed immediately preceding the fifth stage 60, wherein high angle ion beam milling can be employed to first thin down the alumina sidewall layer 80 before utilizing megasonic action to crack the sidewall layer 80 in the fifth stage 60. Moreover, following the initial megasonication process at the fifth stage 60, ultrasonication with hot NMP can be performed followed by a second megasonication process. This has been found to provided good results during testing, perhaps because the ultrasonication with hot NMP after the first megasonication process further ensures cracking of the sidewall dielectric layer sufficiently to enable the lift-off solution to come into contact and react with the photoresist 71, while the second megasonication process further allows not only the cracking of the dielectric layer, but also allows for the lifted off features to be carried away from the surface of the wafer. Moreover, other conventionally known processing stages can also be added. For example, ion beam etching of the sensor stack typically damages the outer surfaces of the photoresist 71, causing a crusty layer generally impervious to further processing by solvents. Therefore, a common process, referred to as “ashing,” is used which volatizes the damaged outer surfaces of the photoresist 71 in a plasma atmosphere containing oxygen. If the damaged outer surface of the photoresist 71 is not removed, it can prevent the lift-off solution from reacting with the photoresist 71. Another, final processing stage can be cleaning the wafer using a process commonly known as “snow clean.” In the snow clean process, compressed carbon dioxide (solid) is blown onto the surface of the wafer, after the photoresist 71 has been stripped, off in order to completely clean off any remaining particulate debris from the wafer surface.

It should be also understood that the particular selection and sequence of the particular processes, both as described above and also with regard to certain example processes described hereinafter, are chosen by way of example for describing certain preferred embodiments of the invention, and that such selection and sequence can be varied according to the particular application. As such, the invention is not intended to be limited to the selection and sequence described herein.

In a certain embodiment of the invention, megasonic energy is applied to the shield 65 in the fifth stage 60 of the process using a specially formulated lift-off fluid as the wave propagation medium for the megasonic energy. In addition to assisting in the lift-off process, the lift-off fluid can also serve to wash away the detached structures after lift-off, leaving the structure shown in stage 62 in FIG. 4.

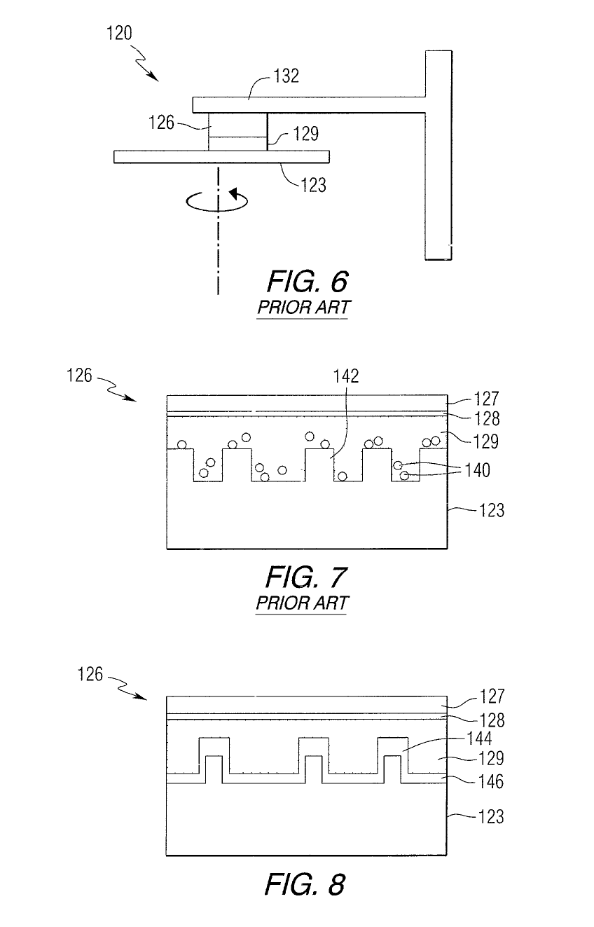

Conventional ultrasonic cleaning typically operates at 20 to 350 kHz with continuous power input, which can result in the production of random, and occasionally violent, cavitation. High intensity acoustic waves generate pressure fluctuations in the liquid medium which result in the formation of cavitation bubbles. In comparison, megasonic cleaning can operate at frequencies of 700 kHz to 1 MHz. Prior art devices are known to be used in the prior art to clean the surfaces of wafer, i.e., to remove particle contamination from the surface features and trenches of the wafer surface. A simplified schematic diagram of one type of prior art megasonic device 100 for cleaning wafers is shown in FIG. 5. As can be seen, the megasonic cleaning device 100 does not utilize the application of localized, concentrated megasonic energy on the surface of the wafer 103. Rather, the megasonic transducer 106 is held stationary near the bottom of a tank 109 containing the fluid 112 which serves as the wave propagation medium for the megasonic energy. The wafer 103 is held in an upper portion of the tank 109, far from the megasonic transducer 106. The relatively distant spacing of the wafer 103 from the megasonic transducer 106 results in the megasonic power being delivered in a diffuse, non-localized fashion. Another type of prior art megasonic cleaning device 120 is shown in FIGS. 6 and 7. This particular cleaning device 120 is configured to deliver concentrated megasonic power directly to the surface of the wafer 123. Localized, concentrated application of power to the surface of the wafer 123 is provided by positioning a megasonic transducer assembly 126 in close proximity to the surface of the wafer 123, so as to hold a very thin liquid meniscus 129 therebetween. This type of megasonic cleaning device is available from manufacturers such as Solid State Equipment Corporation, having a place of business in Horsham, Pa., and Verteq Company, having a place of business in Santa Ana Calif. Referring particularly to FIG. 7, the megasonic transducer assembly 126 can include a megasonic head portion 127 and megasonic transducer element 128. The megasonic transducer element 128 is typically made out of materials such as quartz or lead zirconium titanate, also referred to as “PZT.” The megasonic transducer element 128 is placed in close proximity and parallel to the top (active) surface of the wafer 123 to be cleaned. The transducer assembly 126 covers a fraction of the surface area of the wafer 123 to be cleaned. During operation, the wafer 123 is held on a rotating chuck and spun. The megasonic fluid 129 is dispensed from the transducer fixture 132, into the space between the megasonic transducer assembly 126 and the active surface of the wafer 123. The fluid 129 is generally held in place by the surface tension between the fluid 129 and the surface of the wafer 123. The fluid meniscus 129 serves as the medium to transmit the megasonic energy efficiently from the transducer element 128 to the surface of the wafer 123. The gap between the transducer element 128 and the surface of the wafer 123 is typically between 1 mm and 5 mm, which generally corresponds to the thickness of the fluid meniscus 129. The thin megasonic fluid meniscus 129 serves as an efficient medium to transfer the megasonic energy to the surface of the wafer 123.

In the prior art, megasonic transducers are known to be used for particle contamination removal from the surface of the wafer 123 during etch, ash and chemical mechanical polish. As illustrated in FIG. 7, in such cleaning processes the megasonic waves from the transducer element 128 interact with free-floating particles 140 on the surface of the wafer 123, and effectively remove the particles 140 by non-contact means. Liquid chemical reactions and the megasonic acoustic energy combine to effect removal of the particles 140. Non-contact cleaning of the particles 140 from the surface of the wafer is achieved through the transmission of megasonic energy from the transducer element 128 to the surface of the wafer 123 through the meniscus 129.

Referring now to FIG. 8, and according to a certain embodiment of the invention, megasonic energy is utilized not for cleaning the surface of the wafer 123, i.e., particulate removal, but rather as an instrument to fracture the dielectric sidewall 80 of the thin film layer 77, such as shown in FIG. 4, in order to assist lift-off. The megasonic device 120 is employed to apply concentrated megasonic energy to the surface of the wafer 123 to rupture the dielectric sidewall layer 80 to release the photoresist lift-off structures 71 which are desired to be lifted off. Thus, a unique aspect of the lift-off process according to a certain embodiment of the invention is the use of megasonic energy to enable the definition of the fine sub-micron device features. Only as a secondary feature is the megasonic energy used to additionally clear the surface of the wafer 123 of particle contamination, such as the particles 140 shown in FIG. 7. The lifted-off features are washed away from the surface of the wafer 123 by the lift-off fluid 129 which is dispensed through the megasonic transducer fixture 132.

Additionally, a megasonic lift-off process according to a certain embodiment of the invention can avoid problems associated with cavitation. In particular, the ceramic piezoelectric crystals of the transducer element 128, which can generate frequencies of typically from 700 kHz to 1 Mhz, can be switched on and off in a cyclic fashion to produce controlled cavitation and uniform waves that can virtually eliminate the likelihood of detrimental surface damage caused by cavitation erosion. This pulsed input power also achieves greater acoustic power levels than continuous input at the same power.

Fracturing of the dielectric sidewall layer 80 additionally facilitates direct contact between the lift-off fluid 129 and the photoresist 71, which can promote and activate the lift-off process. The lift-off fluid 129 flows through the cracked dielectric sidewall layer 80 and reacts with the underlying photoresist 71, thereby initiating the lift-off process. Cracking the dielectric sidewall layer 80 can also enable further enhancements of the lift-off process according to certain embodiments of the invention. One such enhancement can include using surfactants in the lift-off fluid 129, which lowers the surface tension and thus enhances wetting to further aid in the detachment of the lift-off structures. Enhanced wetting can be achieved through the use of well known surfactants such as, for example, DM30™ and Triton X100™.

Another significant enhancement can include specially formulating the chemistry of the lift-off fluid 129 to create repulsive Van der Waal forces between the lift-off structures, e.g., the photoresist 71 and/or excess dielectric 77, and the underlying sensor 68 to effect detachment therebetween to successfully complete the lift-off process. In particular, the megasonic lift-off fluid 129 can be specifically formulated so as to create like charges in adjacent surfaces of the lift-off structures and the underlying surfaces from which the lift-off structures are to be detached. Since like charges repel, the like charges created in the adjacent surfaces cause the lift-off structures and underlying surfaces to repel each other, thus effecting/enhancing successful detachment of the lift-off structures.

Controlling the chemistry of the lift-off fluid in this manner can be particularly effective after fracturing of the dielectric sidewall layer 80 by megasonication, since that facilitates entry of the lift-off fluid into the photoresist/substrate interface. However, it will be obvious to those of ordinary skill in the art that such advantages from formulating the lift-off fluid to create repulsive Van der Waals forces may be realized in a variety of other conventional lift-off processes wherein a lift-off fluid is employed, even though such process may not utilize megasonic energy (such as in conventional ultrasonication processes). Accordingly, formulation of a lift-off fluid to create repulsive Van der Waals forces as described herein is not to be limited solely to lift-off processes which utilize megasonication in the manner disclosed in this application.

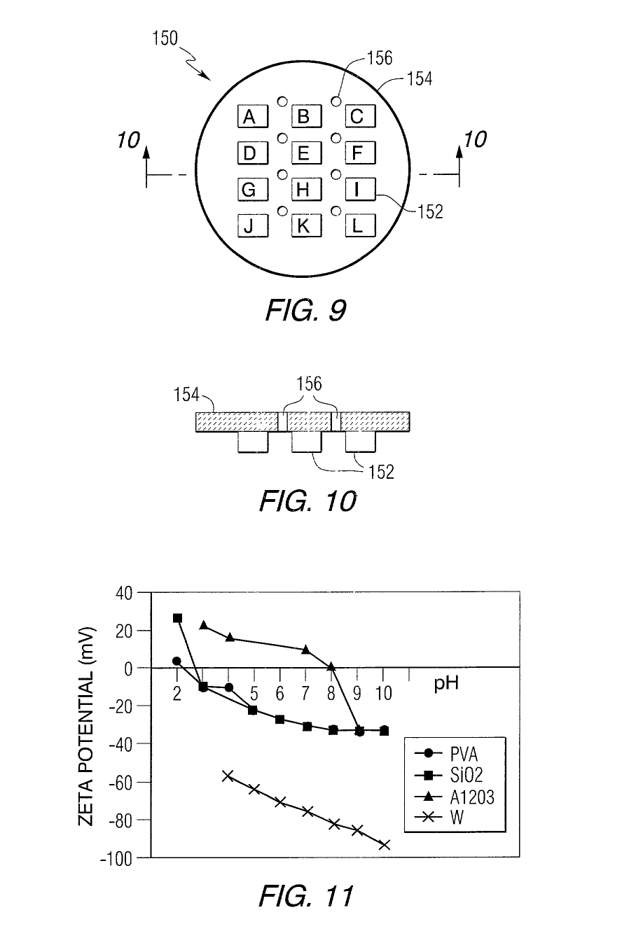

Referring now to FIGS. 9 and 10, a certain embodiment of a transducer head 150 is shown having an array of transducer elements 152 provided on a mounting member 154. In general, different frequencies of megasonic energy can be effective in lifting off features of a particular size. In practice, device wafers will likely have devices with a range of feature sizes to be lifted off. Thus, a single megasonic transducer operating at a single frequency may not be the most optimal to perform efficient liftoff on a wafer having such a range of device features. A solution to this problem, according to a certain embodiment of the invention, is provided by the megasonic head 150 having the array of transducers 154. By employing an array of transducers 154, each utilized at a unique operating frequency, it can be possible to better effect a liftoff process on wafers which have a range of feature sizes to be lifted off.

As shown in FIG. 9, the megasonic head 150 can have a 12 transducer array consisting of transducers 154, individually labeled, e.g., A, B, C, D, E, F, G, H, I, J, K, and L. The transducers A-L can be operated at a range of megasonic frequencies, e.g., F_{A}, F_{B}, F_{C}, F_{D}, F_{E}, F_{F}, F_{G}, F_{H}, F_{I}, F_{J}, F_{K}, and F_{L}. Frequencies F_{A}-F_{L} can be the resonant frequency of operation of the individual megasonic transducers A-L in the array 154. Each of the frequencies F_{A}-F_{L} can be chosen as the most effective frequency for removing lift-off structures and defining wafer features in a certain size range. Moreover, in addition to operating each of the transducers elements 154 at different frequencies, the transducer elements can be operated at varying power levels, e.g., P_{A}, P_{B}, P_{C}, P_{D}, P_{E}, P_{F}, P_{G}, P_{H}, P_{I}, P_{J}, P_{K}, and P_{L}. In this circumstance, P_{A}-P_{L} can be the operating power levels of the individual megasonic transducer elements 154.

In addition to the multiple transducer elements 154, the megasonic head 150 can also dispense megasonic fluid, for example through the mounting member 154, so as to form a fluid meniscus between the megasonic transducer array 154 and the wafer surface. In particular, as shown in the cross section view in FIG. 10, multiple ports 156 can be provided through the mounting member 154 for dispensing the megasonic lift-off fluid in a manner similar to the prior art megasonic device 120 shown in FIGS. 6 through 8.

In the working examples of certain preferred lift-off processes which will now be described, including in connection with the description of FIGS. 11 through 16b, negative surface charges can be created on the sensor 68 and the adjacent surface of the photoresist layer 71, and the dielectric layer 77, which provides for charge repulsion (repulsive Van der Waals forces) so as to attain clean lift-off of dielectric layer 77, along with the photoresist 71, from the sensor stack 68.

According to a certain embodiment of the invention, a method to achieve effective lift-off using repulsive Van der Waals forces can be implemented through the control of the pH of the megasonic lift-off solution 129. As will be explained in more detail below, control of the pH of the lift-off fluid 129 can be achieved through the use of bases such as ammonium hydroxide. Other bases can also be used, for example KOH. Additionally, buffer solutions can also be used to regulate the pH, and the invention should thus not be limited to any particular method of controlling the pH of the lift-off fluid 129. The pH can be chosen so as to cause the surface charge repulsion between a substrate and lift-off structure. In addition, a chemical additive such as hydrogen peroxide can also be added to the lift-off fluid 129 so as to preferentially oxidize the photoresist surface with oxidizer, further enhancing separation of the lift-off structures.

Effective design of lift-off processes for submicron features requires an understanding of the intersurface forces. The following discussion briefly addresses this point, and further explains the relationship of the pH of the lift-off fluid in regard to creating repulsive Van der Waals forces between a substrate and lift-off structure.

There are three classes of forces that act on a particle suspended in a fluid medium: (a) Van der Waals forces (b) capillary forces and (c) gravitational forces, namely centrifugal forces and vibrational forces.

Van der Waals Forces:

Solid surfaces in liquid media form a double layer of charge through absorption of ions of dissociation of surface groups. These two layers, which are oppositely charged with respect to each other, are collectively called the “electrical double-layer.” The boundary between them is called the shear plane. The electrical potential at the shear plane, defined as the Zeta potential, determines whether a particle will be attracted or repelled by another charged surface in the fluid if their respective electrical double-layers overlap. The Zeta potential varies as a function of pH for various surfaces, metal and oxide. An example of this variation is shown in FIG. 11. Generally, Zeta potential is positive in acidic solutions and negative in basic solutions.

The dominant adhesion mechanism in liquid media is the long-range Van der Waals force, the magnitude of which—for a sphere adhering to a flat substrate—is given by the equation:

$${F}_{vdw} = - \frac{Ar}{6 {Z}^{2}}$$

In this equation, r is the sphere radius, z is the distance of separation between sphere and substrate (typically taken to be 4 Angstroms), and A is the Hamaker constant (a property of the materials involved). If two substances have Hamaker constants A₁₁ and A₂₂, the Hamaker constant between them is given by the equation:

A₁₂=√A₁₁A₂₂

If the two substances are immersed in a medium, e.g., medium 3, then the Hamaker constant for the system is given by the equation:

A₁₃₂=c(A₁₂+A₁₃−A₁₃−A₂₃)

In this equation, the constant c is about 1.5 to 1.6 for water. The relationship between Van der Waals force and particle diameter means that the adhesion force will decrease linearly with decreasing particle size. The forces of Van der Waals attraction or repulsion of a feature of material 1 interacting with a surface 2 through medium 3 are given by the equation:

$${F}_{adhesion} = \frac{{A}_{132}}{12 {( {Z}_{0} )}^{2}}$$

where A₁₃₂ is the Hamaker constant of a sphere (material 1) adjacent to a plane (material 2) in a medium (material 3).

Accordingly, for lift-off processes, fluids that increase the electrostatic repulsion can be selected for use as the megasonic lift-off fluid.

Capillary Forces:

The force of capillary adhesion (or repulsion) between a particle and a surface in contact through an intermediate fluid of surface tension y, is given by the equation:

F_{cap}=2πγd_{feature}

In this equation, “d_{feature}” is the diameter of the particle, i.e., “feature.”

Gravitational Forces:

Centrifugal Force:

The centrifugal force exerted on a particle/feature on a spinning wafer is given by the equation:

F_{c}=(π/6)d_{feature}³*(ρₚₐᵣₜ−ρ_{fluid}) (ω²R)

Vibrational Force:

The vibrational force exerted on a particle by megasonic agitation is given by the equation:

F_{vib}=2π³d³_{feature}f²Y*(ρₚₐᵣₜ−ρ_{fluid})

In this equation, f is the frequency of vibration; Y is the amplitude; and (ρₚₐᵣₜ−ρ_{fluid}) represents the density difference between the particle and the fluid.

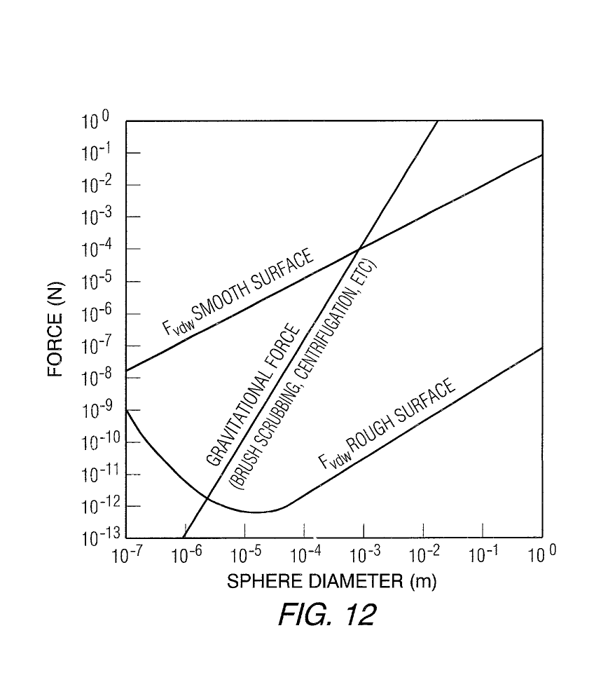

As such, from the above discussion of the various forces affecting particles suspended in fluid mediums, it can be seen that gravitational forces decrease as the square or the cube of the particle diameter as the feature size decreases, whereas the Van der Waals forces decrease only linearly. This variation is depicted in the graph in FIG. 12. It can therefore be appreciated that as the feature/particle sizes decrease, most mechanical particle removal techniques using forces such as hydrodynamic drag and/or centrifugal force, the removal forces are proportional to the second or third power of the particle radius, and therefore decrease at an extremely high rate for dimensions smaller than 1 μm. On the other hand, the Van der Waals forces decrease linearly for such particles. The net result is that the Van der Waals forces of attraction are about 3 to 5 orders of magnitude higher than the gravitational forces for features smaller than 0.5 μm. Thus, there follows two consequences: (a) smaller feature sizes are more difficult to remove through conventional mechanical gravity-based techniques and hence are difficult to lift-off cleanly; and (b) for Such sizes, the controlling the sense and magnitude of the Van der Waals forces (adhesive/repulsive forces) is critical to efficient lift-off removal.

A few example processes are described below in detail, which demonstrate certain embodiments of a single layer resist lift-off process according to the invention. In the examples below, alumina is the thin film dielectric being lifted off. However, it is to be understood that the invention is not limited to alumina thin films alone, and other types of thin film material combinations can also be subject to the lift-off process in a similar fashion.

Moreover, the invention is not limited to embodiments which utilize the same steps as exactly described, or exactly the same number or order of steps in the examples below. Rather, the particular process are provided merely as examples of specific processes which successfully utilized various aspects of certain embodiments of the invention. The details of the particular processes listed in each step of the following examples are described more in the preceding description of the invention, or are otherwise understood by those of ordinary skill in the art.

### EXAMPLE 1

This particular lift-off process was carried out according to the following sequence:

Deposit Sensor Stack

Spin Negative E-Beam resist, expose, develop

Ion Beam Etch (IBE) sensor stack

Deposit dielectric layer

Lift-off Assist Ion Mill

Megasonicate with DM30 (mixed 1:20 with DI Water) for 2 cycles of 80 seconds each, with a flow rate of 800 ml/min, megasonication frequency of 1.5 MHz, and transducer power of 100 watts

Ultrasonicate with hot NMP for 45 min

Megasonicate again with DM30

Ash

Strip

Snow Clean

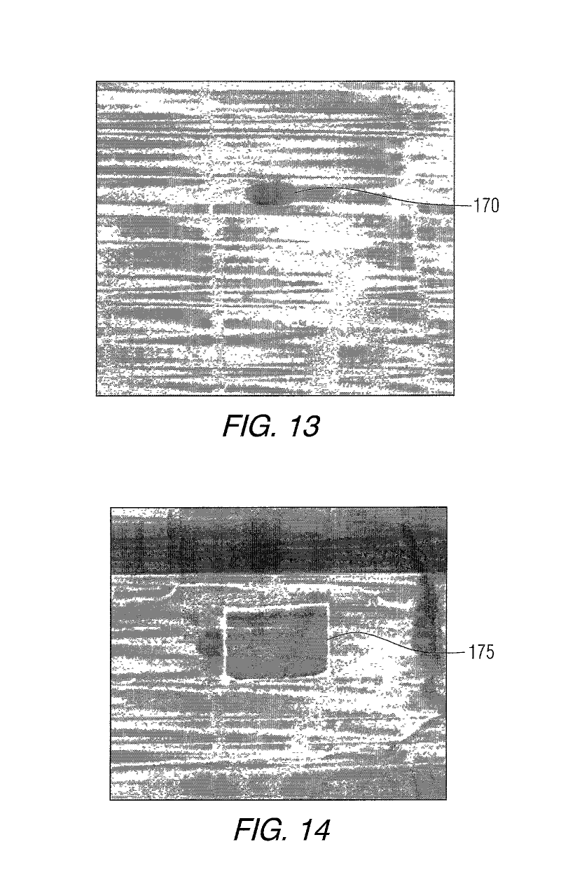

The lift-off process was accomplished using the above process sequence on both a large (1 μm) sensor feature, as well as a smaller (0.1 μm) feature 170. FIG. 13 is a pictorial representation of the surface of the wafer showing the 0.1 μm feature after performance of all of the steps listed above.

### EXAMPLE 2

This particular lift-off process was carried out according to the following sequence:

Deposit Sensor Stack

Spin Negative E-Beam resist, expose, develop

Ion Beam Etch (IBE) sensor stack

Deposit dielectric layer

Lift-off Assist Ion Mill

Megasonicate with DM30 (mixed 1:20 with DI Water) for 80 seconds, 2 cycles, 1.5 MHz frequency, 100 watts, wave propagation fluid dispensed at a flow rate of 800 ml/min

Ultrasonicate with hot NMP (60° C.) for 45 min

Megasonicate with a solution containing 2% NH₄OH and 0.15 w/0 Triton X-100 surfactant

Ash

Strip

Snow Clean

This lift-off process was accomplished using the above process sequence on both a large (1 μm) sensor feature, as well as a smaller (0.1 μm) feature 175. FIG. 14 is a pictorial representation of the surface of the wafer showing the 0.1 μm feature 175 after performance of all of the steps listed above.

### EXAMPLE 3

This particular lift-off process was carried out according to the following sequence:

Deposit Sensor Stack

Spin Negative E-Beam resist, expose, develop

Ion Beam Etch (IBE) sensor stack

Deposit dielectric layer

Lift-off Assist Ion Mill

Megasonicate w/2% NH₄OH+0.2 v/o Triton X-100 Surfactant, 2 cycles of 80 s each, 1.5 MHz frequency, 100 watts, fluid dispensed at a flow rate of 800 ml/min

Ash

Strip

Snow Clean

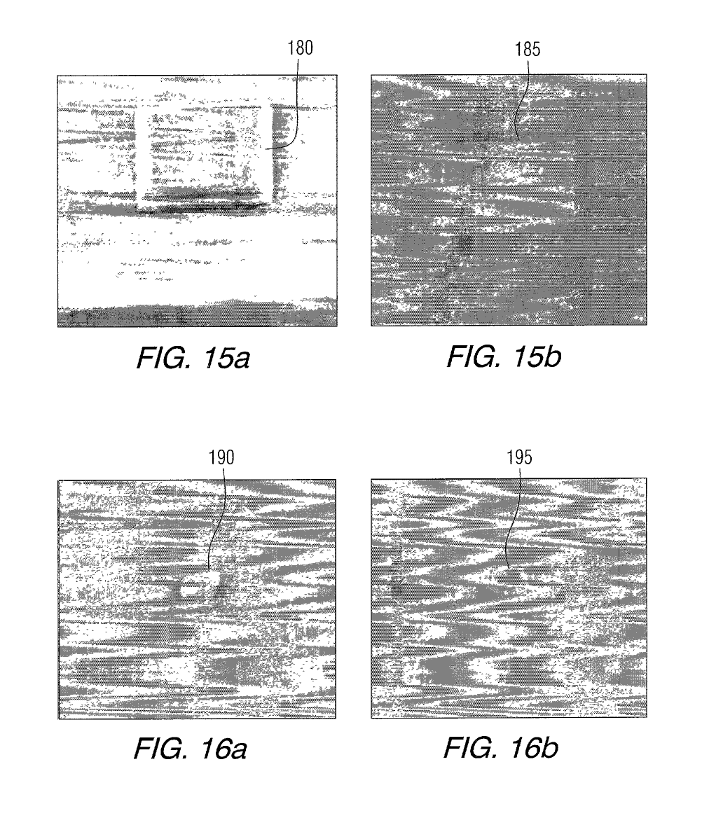

This lift-off process was accomplished using the above process sequence on both a large (1 μm) sensor feature, as well as a smaller (0.1 μm) features. FIG. 15a shows the 1 μm sensor feature 170 before lift-off, and FIG. 15b shows the same feature 175 after the lift-off structure has been lifted off. Similarly, according to the same process listed above, FIG. 16a shows a smaller 0.500 m feature 190 before lift-off, and FIG. 16b shows the same feature 195 after the lift-off structure has been lifted off.

Although certain embodiments of the invention have been described in detail, it will be appreciated by those skilled in the art that various modifications to those details could be developed in light of the overall teaching of the disclosure. Accordingly, the particular embodiments disclosed herein are intended to be illustrative only and not limiting to the scope of the invention which should be awarded the fill breadth of the following claims and any and all embodiments thereof.

What is claimed is:

1. A resist lift-off process comprising:
covering at least a portion of a substrate surface with a photoresist;
depositing a dielectric layer on said substrate surface and said photoresist resulting in a sidewall dielectric layer being formed on a side of said photoresist; and
applying megasonic energy to said substrate surface via a thin meniscus of lift-off fluid to crack said sidewall dielectric layer.

2. The lift-off process of claim 1 further comprising adding a surfactant to said lift-off fluid to enhance wetting of said photoresist and said dielectric layer.

3. The lift-off process of claim 2 further comprising ultrasonicating said substrate surface subsequent to applying said megasonic energy.

4. The lift-off process of claim 3 further comprising applying said megasonic energy a second time.

5. The lift-off process of claim 1 further comprising formulating said lift-off fluid to chemically react with said photoresist to initiate lift-off of the photoresist.

6. The lift-off process of claim 1 further comprising formulating said lift-off fluid to create repulsive Van der Waals forces between said photoresist and said substrate surface to effect separation therebetween.

7. The lift-off process of claim 6 further comprising controlling said repulsive Van der Waals forces by controlling a pH of said lift-off fluid.

8. The lift-off process of claim 7 further comprising formulating the lift-off fluid to oxidize said photoresist.

9. The lift-off process of claim 1 further comprising:
a metal feature provided intermediate said substrate surface and said photoresist; and
formulating said lift-off fluid to create repulsive Van der Waals forces between said photoresist and said metal feature.

10. The lift-off process of claim 1 further comprising reducing a thickness of said sidewall dielectric layer prior to applying said megasonic energy.

11. The lift-off process of claim 10 wherein said reducing a thickness of said sidewall dielectric layer further comprises performing low angle ion milling.

12. The lift-process of claim 1 wherein said applying megasonic energy further comprises pulsing said megasonic energy on and off.

13. An apparatus for applying megasonic energy to the surface of a substrate comprising a transducer fixture having a megasonic head assembly, said megasonic head assembly having a plurality of megasonic transducer elements, each of said plurality of transducer elements individually operable in at least one of variable frequencies and variable power levels.

14. The apparatus of claim 13 further comprising:
a member adapted to hold a wafer parallel and in close proximity to said megasonic head assembly;
a thin meniscus of wave propagation fluid provided between said megasonic head assembly and surface of said wafer for application of megasonic energy to said surface.

15. The apparatus of claim 14 further comprising a source of said wave propagation fluid in communication with said megasonic head assembly; and
said megasonic head assembly having at least one port therethrough for dispensing said wave propagation fluid to form said thin meniscus between said megasonic head assembly and said surface.

16. A resist lift-off process comprising:
covering at least a portion of a substrate surface with a photoresist;
depositing a dielectric layer on said substrate surface and said photoresist;
applying acoustic energy to said substrate surface via a lift-off fluid to facilitate lift-off of said photoresist; and
formulating said lift-off fluid to create repulsive Van der Waals forces between said photoresist and said substrate surface to effect separation therebetween.

17. The lift-off process of claim 16 further comprising controlling said repulsive Van der Waals forces by controlling a pH of said lift-off fluid.

18. The lift-off process of claim 17 wherein controlling said pH further comprises adding at least one of a base and a buffer solution to said lift-off fluid.

19. The lift-off process of claim 16 further comprising formulating said lift-off fluid to chemically react with said photoresist to initiate lift-off of the photoresist.

20. The lift-off process of claim 19 further comprising formulating the lift-off fluid to oxidize said photoresist.

21. The lift-off process of claim 16 further comprising adding a surfactant to said lift-off fluid to enhance wetting of said photoresist and said dielectric layer.

22. The lift-off process of claim 16 wherein applying said acoustic energy further comprises applying megasonic energy.

23. The lift-off process of claim 22 further comprising ultrasonicating said substrate surface subsequent to applying said megasonic energy.

24. The lift-off process of claim 23 further comprising applying said ultrasonic energy a second time.

25. The lift-off process of claim 16 further comprising:
providing a metal feature intermediate said substrate surface and said photoresist; and
formulating said lift-off fluid to create repulsive Van der Waals forces between said photoresist and said metal feature.

26. The lift-off process of claim 16 wherein said applying acoustic energy further comprises applying megasonic energy.

27. The lift-off process of claim 26 wherein:
said applying acoustic energy further comprises applying megasonic energy; and
said applying ultrasonic energy a second time further comprises applying megasonic energy a second time.
